(19) United States
(12) Patent Application Publication
(10) Pub. No.: US 2009/0292824 A1
(43) Pub. Date: Nov. 26, 2009

(54) System And Method For Application Acceleration On A Distributed Computer Network

(75) Inventors: Ali Marashi, Herndon, VA (US); James Eric Klinker, Atlanta, GA (US)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: INTERNAP NETWORK SERVICES CORPORATION, Atlanta, GA (US)

(21) Appl. No.: 11/814,351

(22) PCT Filed: Jan. 23, 2006
(86) PCT No.: PCT/US2006/002129

§ 371 Date: Apr. 20, 2009

Related U.S. Application Data
(60) Provisional application No. 60/645,906, filed on Jan. 21, 2005.

(51) Int. Cl. G06F 15/16

(52) U.S. Cl. 709/247

(57) ABSTRACT

Application acceleration is provided across a widely deployed network. In one embodiment a number of servers throughout the network provide address translation, acceleration, and performance measurements and are organized as service deliver points (SDPs). Collectively the SDPs form an application service network provider (ASNP) located between the client and the application server Traffic is routed from the client to a client SDP, which includes an accelerator, from the client SDP to a server SDP, which includes a matching accelerator, and from the server SDP to the application server. Return traffic follows a similar, but revere path.

### TECHNICAL FIELD

This invention relates generally to information transfer for network-based applications on a computer network. More particularly, the invention is related to application acceleration across a network that does not require accelerators at both endpoints.

### BACKGROUND

The Internet is rapidly becoming a global business network, where partners and clients can easily access mission critical applications from anywhere in the world. In some instances (e.g. outsourcing), application users are increasingly far away from the network application servers and the associated data and content on those servers. Yet application developers often write network applications under the assumption of local area network or LAN access. LAN performance is by definition low latency and easily and economically over-provisioned meaning little packet loss and low jitter. Often, when those applications operate over vast distances as is common on the Internet, network conditions such as high latency, packet loss and jitter dramatically impact the performance of those applications.

For some applications where the content is static and does not change, a Content Delivery Network or CDN can be used to address this problem. The CDN solves the problem by placing a copy of the content at a location that is close to the ultimate user or client. Companies such as Speedera and Akamai have helped certain businesses address the performance problems inherent in the Internet, in those instances where the application data is easily cached, accessed often by many users and most importantly, static.

For dynamic applications where the underlying data is different for different users (e.g. an account balance for an online banking application), the CDN cannot address the performance problems without the onerous process of replicating the entire application and all of its associated data near the users. For certain applications, such as financial applications operating on real-time market data, the replication needs to occur in real-time to accommodate the underlying dynamic data changes. The near instantaneous replication of data to all CDN sites is prohibitively expensive and impractical. Other business applications such as CRM, sales order management, database access or backup also require dynamic interaction and data transfer not suitable to the CDN. For many, the cost and overhead in replicating the application all over the world is prohibitive.

CDN solutions are also not appropriate for some emerging real-time applications, such as voice and video where real-time interaction is required between the application participants. These applications demand strict performance requirements of the network in the form of loss, latency and jitter. As such, most long haul network paths cannot match the requirements and these applications degrade or outright fail.

Recently, new approaches for accelerating applications have appeared on the market. Broadly speaking, these application accelerators overcome the limitations of the network and dramatically increase the performance of applications running over the network. They employ various techniques such as TCP acceleration, session splitting, compression, virtual window expansion, data segment caching, application layer acceleration and route control to overcome long distance, high packet loss, small constrained networks and poorly written applications. Companies such as Peribit, Riverbed, Orbital Data, Expand, Allot, Internap, and Packeteer are developing hardware that employs one or more of the above or similar techniques in the pursuit of increased application performance. While these techniques are helpful, they will not help the application scale when the user base is large or global. Additionally, many applications have a user base that is not known a priori. Consider a business-to-consumer (B2C) application or a business application that is accessed from traveling workers or telecommuters. The one-to-many and the open nature of these applications presents a significant challenge to anyone wishing to deploy stand alone solutions in support of these applications. The prospect of placing this technology at every application user or client is cost prohibitive and not practical for the applications with a large and geographically disbursed user base.

In addition to the above scalability concerns, an application manager would need to lease and operate physical space and systems in remote locations. In addition, the application manager would need to buy and maintain the software and hardware necessary to effectively utilize and load balance many such sites. Currently, application mangers would have to waste economic and other resources on functions that are not relevant to their core business.

In summary, there is need for cost effective acceleration of many applications over large geographical distances when application data is dynamic or is not cost effectively cached by solutions such as CDN. The present invention solves these and other problems associated with the prior art.

The present invention meets the needs described above by providing a system and method for intelligently routing and accelerating applications over a large network of servers in a way that dramatically improves the transport times and enhances user experience of the application. The present invention provides a set of servers operating in a distributed manner. The application traffic is routed through the server network and accelerated along a portion of the network path. In one embodiment, the major components of the network include a set of servers running DNS, a set of servers measuring network and server performance metrics, a set of servers to translate addressing, a set of servers to implement the acceleration techniques and a set of servers for reporting and customer management interfaces. The servers perform the necessary processes and methods of the invention and, as will be apparent to those skilled in the art, these software systems can be embedded on any appropriate collection of hardware or even embedded in other products. These servers are deployed throughout the globe in a series of Service Delivery Points (SDPs). The SDPs collectively make up the Application Service Network Provider (ASNP). The present invention also contemplates that the collection of the individual functions described above can be deployed throughout the network and need not be organized into the SDPs of the disclosed embodiment.

The invention provides a network architecture that allows an application provider to accelerate their applications over long distances and under less than ideal network conditions, as is commonly found in some underdeveloped portions of the world or with satellite networks. The applications are automatically routed over the accelerated network without any effort or overhead on the part of the clients or application provider.

The global framework is fault tolerant at each level of operation. Different SDPs can be engaged and used in the event of any single failure and still achieve good levels of application acceleration. Individual and system level components of the SDPs also fail over to other systems in the same SDP or in a nearby SDP.

It is an object of the present invention to provide a computer network comprising a number of widely deployed servers that form a fault tolerant infrastructure designed to accelerate applications efficiently and reliably to end users. A more general object of the present invention is to provide a fundamentally new and better way to transport Internet applications.

Another object of the present invention is to provide a fault tolerant network for accelerating the transport of Internet applications. The network architecture is used to speed up the delivery of the applications and allows application providers with a large audience to serve the application reliably and with dramatically improved application experience due to greater network throughput.

Yet another objective of the present invention is to provide a network architecture that is able to improve the application experience without the need to replicate content or data near the users. This allows applications with dynamic data or large amounts of data to be accelerated with significantly less cost in server and disk at the various network locations resulting in a more cost effective solution.

Yet another objective of the present invention is to provide a network architecture that improves the performance of applications that are used infrequently and thus, not effectively served by caching solutions. Caching solutions often resort to the origin of the content on a cache miss and this performance is at the base performance of the underlying network.

Yet another objective of the present invention is to provide a network architecture that improves the performance of applications without disrupting the relationship with the end users. The network should allow for the acceleration of applications without additional equipment or software required at the end user or client.

Another objective of the present invention is to provide a network architecture that improves the performance of applications without disrupting the application infrastructure and does not require additional equipment or software at the application server or application server networks. However, in some embodiments of the present invention technology is collocated near the application to enable further improvements in application user experience or lower the cost of the solution.

Yet another object of the present invention is to provide a distributed scalable infrastructure that shifts the burden of application performance from the application provider to a network of application accelerators deployed, for example, on a global basis.

The forgoing has outlined some of the more pertinent objects and features of the present invention. These objects should be construed to be merely illustrative of some of the more prominent features and applications of the invention. Many other beneficial results can be attained by applying the disclosed invention in a different manner or by modifying the invention as will be described. Accordingly, other objects and a fuller understanding of the invention may be had by referring to the following Detailed Description and by reference to the figures and claims.

### BRIEF DESCRIPTION OF THE DRAWINGS

FIG. 1 is a block diagram of an exemplary operating environment for the invention.

FIG. 2A is a block diagram of one embodiment of the invention.

FIG. 2B is a block diagram of the embodiment illustrated by FIG. 2A with route control.

FIG. 2C is a block diagram of another embodiment of the invention.

FIG. 3 is a block diagram of yet another embodiment of the invention.

FIG. 4 is a block diagram illustrating the flow of data in one embodiment of the invention.

FIG. 5 is a block diagram illustrating the addressing required for the proper flow of data in accordance with one embodiment of the present invention

FIG. 6 is a flow chart illustrating a method of routing data in accordance with one embodiment of the present invention.

FIG. 7 is a flow chart illustrating a method for selecting a server SDP in accordance with one embodiment of the present invention.

FIG. 8 is a block diagram illustrating the routing of data in accordance with one embodiment of the present invention.

FIG. 9 is a block diagram illustrating the routing of data in accordance with one embodiment of the present invention.

FIG. 10 is a flow chart illustrating a method for selecting a client SDP in accordance with one embodiment of the present invention.

FIG. 11 is a block diagram illustrating the integration of security in one embodiment of the present invention.

### DETAILED DESCRIPTION

The present invention provides application acceleration across a widely deployed network. Briefly described, the invention provides an application service network provider (ASNP) located between the client and the application server, which includes a number of service delivery points (SDPs). The SDPs typically provide address translation, acceleration, and performance measurements. In one embodiment two SDPs are used, a client SDP and a server SDP. Traffic is routed from the client to a client SDP, from the client SDP to a server SDP, and from the server SDP to the application server. Accelerators are provided at the client SDP and the server SDP. Each SDP is generic and can serve both client and server SDP functions for different applications. In another embodiment the client includes an accelerator and traffic is routed from the client to a server SDP and from the server SDP to the application server. In this embodiment, the server SDP includes an accelerator matched to the accelerator associated with the client. In an embodiment where the application server includes an accelerator, traffic is routed from the client to a client SDP and from the client SDP to the application server. In this embodiment, the client SDP includes an accelerator matched to the accelerator associated with the application server.

### Operating Environment

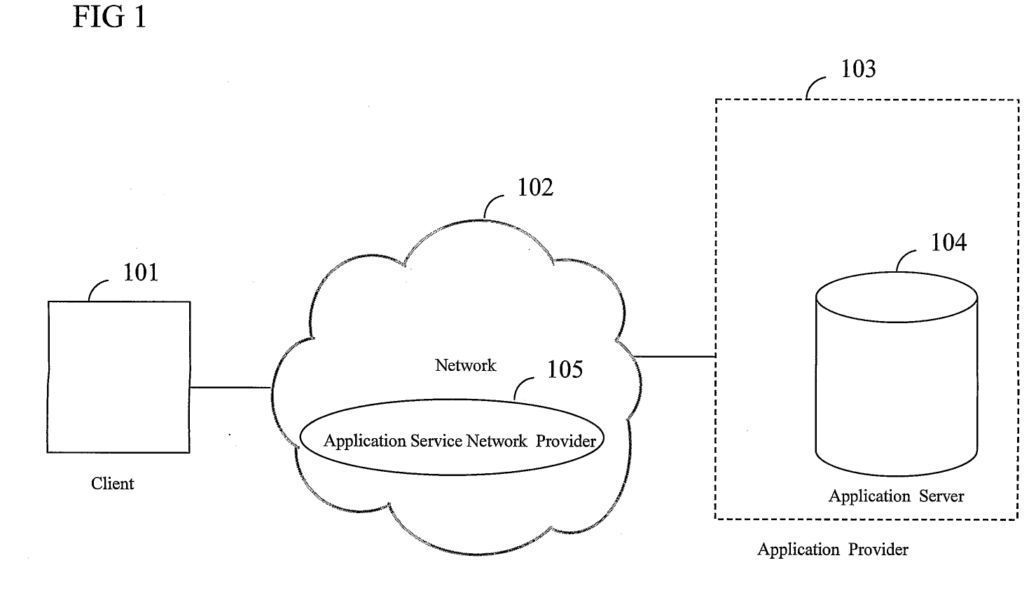

FIG. 1 illustrates an exemplary operating environment for the present invention. A client 101 is connected to an application server 104 via a network 102, such as the Internet, an intranet, an extranet or any other known network. Application provider 103 serves up the application to be accelerated by the present invention. Application server 104 is one of a number of application servers available at the application provider 103. The application servers can be provided at a number of locations. A representative application includes a web-based application to be accessed by a client browser, such as Microsoft Explorer, Netscape Navigator, FireFox, Safari or the like, and accessed using HTTP with or without SSL. The application may also be a file transfer application, such as FTP, or some other variant of file sharing and transfer such as CIFS, Veritas, NetApp, EMC Legato, Sun SAM-FS, Rsync, NSI Double Take. The application may also be a revision control system such as CVS, ClearCase or Accurev. Or the application may be as simple as large email transfer or file transfer using HTTP. The application may be addressable using the DNS, although it may also be statically mapped to a known configured IP address in a given SDP. One disadvantage of static mapping is that is may not provide the same level of fault tolerance. The application must have a method for accessing the ASNP either through DNS or another method integrated with the common use of the application. Application Service Network Provider (ASNP) 105 resides in the network 102 and forms the basis of the present invention for improving the performance of applications between client 101 and application server 104.

### Exemplary Embodiments

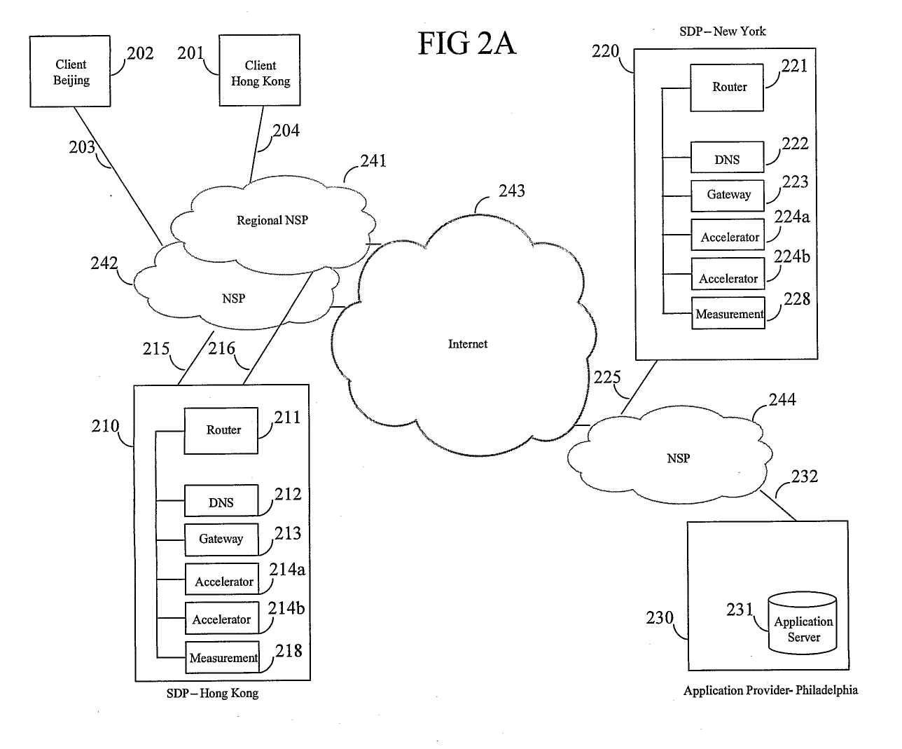

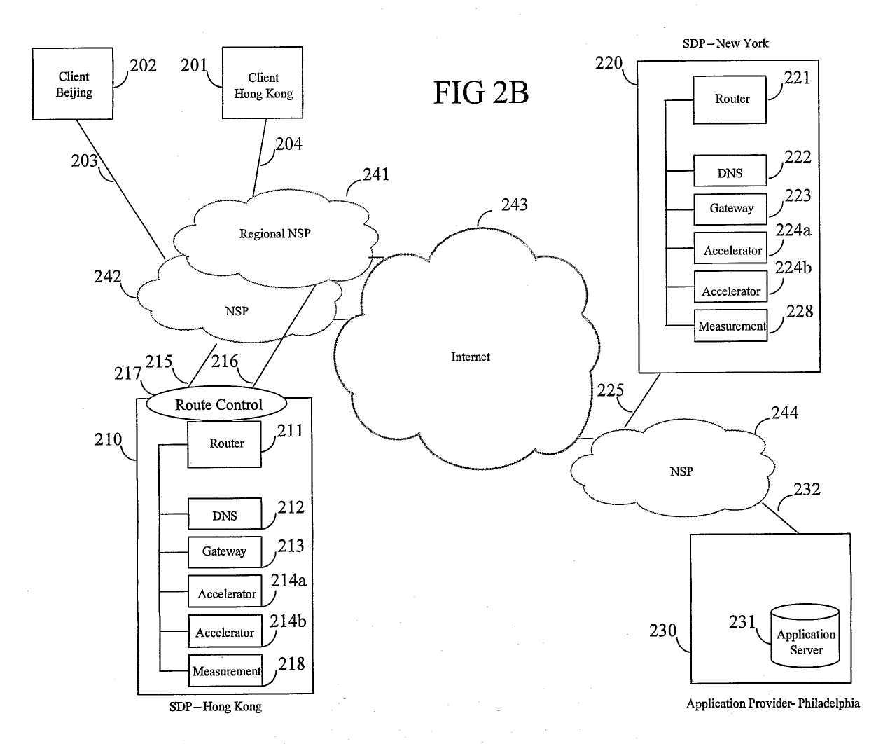

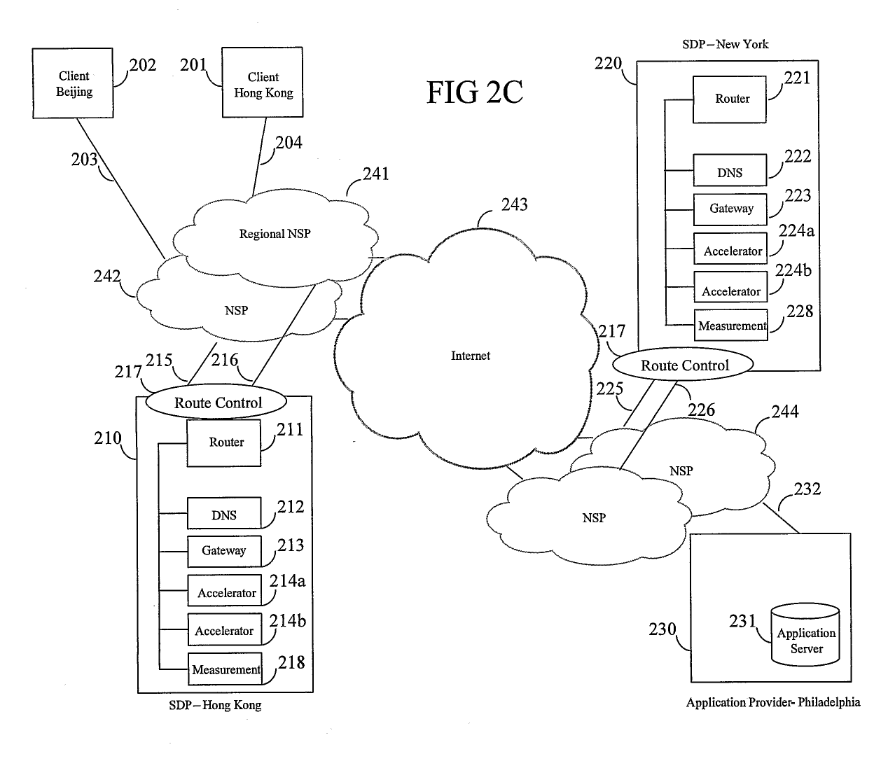

The present invention supports application acceleration in widely deployed networks. In the embodiment illustrated by FIG. 2A, two clients, one located in Beijing 202 and the other located in Hong Kong 201 are accessing an application server 231 located in Philadelphia. Without the ASNP, the network latency between the clients and the application server is large and dramatically affects application performance. With the ASNP, data is intelligently routed to achieve the desired performance improvement.

The clients 201, 202 access the application server 231 via local network connections 203, 204 to networks or network service providers (NSP) 241, 242, 244. The servers of the ASNP are organized into Service Delivery Points (SDPs) 210, 220, which collectively make up the ASNP. The SDPs are connected to the network via one or more network connections 215, 216, 225 using a layer 3 switch or router 211, 221. The SDPs can be connected to a regional or national network or NSP 241, 242, 243, which are further connected to a larger set of networks to form an Internetwork or Internet 243, although other regional, internal or external networks are also possible.

Each SDP includes a number of servers, including a measurement server 218, 220, a DNS server 222, 212 and a gateway server 223, 213, as well as at least one accelerator 224a, 224b, 214a, 214b. The measurement servers 218, 228 measure the availability and performance metrics of each server in the SDP, as well as the network performance such as loss, latency, jitter to both the application servers and the clients or client LDNS servers. The DNS servers 212, 222 respond to requests from a client LDNS and issue unique IP addresses in a given SDP that are best able to serve the client's request.

Although DNS is used in the preferred embodiment, other mechanisms can also be used so long as traffic is routed into the ASNP. In the alternative embodiments that do not use DNS, DNS servers 212, 222 would be replaced with the systems and software necessary to route traffic into the ASNP. The alternative embodiments could use a web service protocol, such as UDDI. Support for a web services registry inside the ASNP could serve to route web services traffic into the SDP for enhancement. Alternative embodiments may access the ASNP as an integrated function of the application itself. Some applications do not require human readable addresses and thus, do not require DNS to access. An example is the delivery of large media files to a set-top box. In this example, the set-top box is not using DNS to access the content. Instead, access to the content is integrated as a part of the delivery application. Accessing the ASNP for such an application would be integrated as a function of the application itself with selection criteria similar to those described for DNS.

The gateway (G/W) server 213, 223 is responsible for translating the source and destination addresses of a given data stream. This address translation corresponds to the underlying routing of the network to ensure traffic is routed through the ASNP via the configured SDP. The G/W server may be implemented in several ways. The preferred embodiment uses Network Adress Translation (NAT) or Port Address Translation (PAT) to translate addresses at the IP layer only. Alternative embodiments may terminate TCP sessions using a full TCP proxy that can be configured to translate the necessary layer three IP addressing. The address translation is critical to ensure traffic is routed through the correct accelerator. The GIW servers may also perform admission control and other functions necessary to ensure only authorized traffic utilizes the network.

The accelerators 214a, 214b, 224a, 224b perform one or more known techniques to accelerate applications. TCP acceleration is probably the most common and is used to improve the throughput of any TCP session. Since the acceleration techniques must interoperate with existing network stacks in the clients and application servers, the original TCP session must be restored at another accelerator associated with the application server. Acceleration is an end-to-end stateful function and requires that traffic is routed through a compatible pair of accelerators for the duration of the session. Other acceleration techniques that can be used with the present invention are described in the section entitled “Exemplary Acceleration Techniques.” Depending on the nature of the techniques, the accelerators may also perform an additional proxy of application protocols (and address translation) of the underlying data stream.

Additional servers not shown in FIG. 2A can be used to implement a reporting portal, where various statistics on the performance of the network and applications are available. Also not shown are management servers where customers can modify or customize the service based on changing requirements. These servers will be tied into the billing systems and automatically update the service level the customer has elected to pay for.

The SDPs provide a fault tolerant infrastructure. If one SDP fails, then application acceleration can be maintained by using another SDP. In addition to substituting one SDP for another, the components within an SDP or between SDPs also can be substituted upon a failure.

FIG. 2B illustrates another embodiment of the present invention where route control 217 is provided within the SDP infrastructure for one of the SDPs, SDP 210. When an SDP is connected to more than one NSP, route control (as described by U.S. Pat. No. 6,009,081 entitled “Private Network Access Point Router for Interconnecting Among Internet Route Providers,” U.S. application Ser. No. 09/833,219 entitled “System and Method to Assure Network Service Levels with Intelligent Routing,” and U.S. application Ser. No. 10/286,576 entitled “Data Network Controller,” all of which are incorporated herein by reference) dramatically improves the quality of routing between the client and the client SDP, the client SDP and the server SDP, and the server SDP and the application server. Route control 217 may be applied in one or more SDPs and applied to any portion of the network paths (client to client SDP, client SDP to server SDP, or server SDP to application server) and in either direction in the delivery network. FIG. 2C illustrates an embodiment where all SDPs are connected to more than one NSP and utilize route control 217. The combination of route control with other acceleration techniques further improves the quality of the application utilizing the delivery network.

Alternative embodiments may rely on an “end to end” form of route control, such as that described in U.S. application Ser. No. 11/063,057 entitled “System and Method for End to End Route Control,” which is incorporated herein by reference, within and between the known SDPs to greatly improve the performance of the long haul portion of the delivery network. This may enable the delivery network for other applications, such as real-time applications (e.g. voice and video) not readily improved by the various other application acceleration techniques employed. Therefore, another embodiment of the present invention may rely on route control without specific application accelerators. Certain acceleration techniques, such as session splitting may further be enhanced when operating over multiple distinct network paths as provided by FIG. 2C. Network paths that are performing better than others may be utilized for more of the intermediate split sessions, while under-performing paths will be less utilized or avoided.

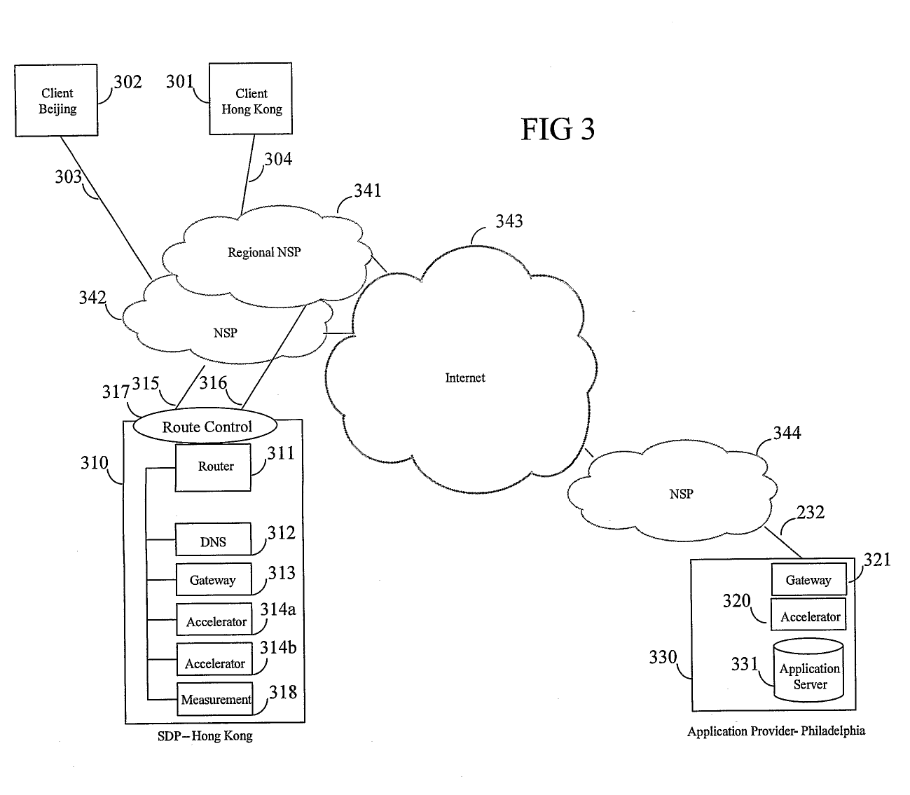

FIG. 3 shows another embodiment of the present invention where only one SDP is used in the flow of data through the network, but there is an additional accelerator 320 and GIW component 321 deployed at the application provider 330, near the application server 331. Although this embodiment only requires one SDP 310 to be used in the flow of data, it requires that the application manager deploy, manage and maintain equipment in addition to the application server 331. The advantage of this embodiment is reduced operational expense. Each data flow will use less traffic and require fewer servers to deploy and support. This embodiment assumes that the application manager has established routing for the application and the SDP through the accelerator 320. Another embodiment only requires the additional accelerator 320 at the application provider 330. The G/W component 321 is not required at the application provider 330.

As will be apparent to those skilled in the art, the described SDPs are not the only way to provide application acceleration according to the present invention. Application acceleration could also be delivered with many of the SDP components implemented as client software to permit the tight coupling of the delivery network with a specific application. For example, ITUNES client software could be a critical component of a delivery network for audio files. As such, the client software could implement many or all of the features associated with the client SDP (e.g. application acceleration) without the downside of client to client SDP network distance, or the difficulties associated with intelligent selection of the client SDP via DNS or other mechanisms.

### Routing Through the ASNP

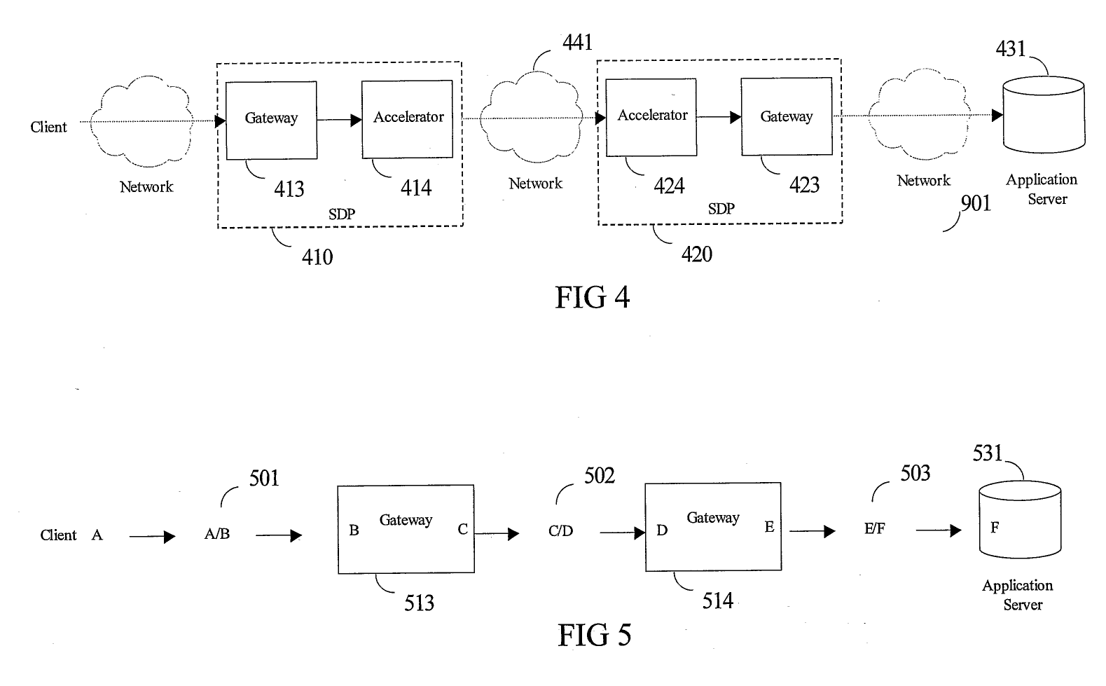

FIG. 4 illustrates the data flow from the client to the application server for an embodiment that uses two SDPs, a client SDP 410 and a server SDP 420. The client sends data to the IP address configured on G/W server 413. Once the G/W server 413 translates the addressing, the data packet is sent to accelerator 414. Along with other packets associated with the session, the accelerator 414 enhances the data stream and hands the packet off to the network 441. The packet is delivered, by the routing established at the address translation, to the matching accelerator 424 that has the same state information for the session as accelerator 414. The addressing set by the G/W server 413 is instrumental to ensuring the data is sent to the proper SDP and thus, the proper accelerator. When multiple accelerators are required due to scale, the specific addressing routes the traffic to the proper accelerator within a given SDP. The matching accelerator 424 modifies the data stream and the original session is restored. Once accelerator 424 processes the traffic it is sent to G/W server 423 for additional address translation. This translation ensures that the resulting communication from the application server 431 for this session is routed back through the same set of infrastructure, i.e. SDPs and servers.

FIG. 5 further illustrates the address translations performed by the NAT/Proxies that result in the desired routing through the network. The client has a source address of ‘A’ and is instructed by the DNS system to reach the application server using destination address ‘B’. Address ‘B’ has been configured on G/W server 513 in a given SDP, preferably an SDP that can provide a desired level of service between the client and the SDP (client SDP). Data packets from the client have a source address of ‘A’ and a destination address of ‘B’ 501. When G/W server 513 is reached, the source address is translated to ‘C’ (another address on the G/W server) and the destination address is set to ‘D’, the destination of a G/W server in another SDP 514, preferably an SDP that can provide a desired level of service between the SDP and the application server 531 (server SDP). Thus, packets leaving G/W server 513 have a source address of ‘C’ and a destination address of ‘D’ 502. The packets are sent through the accelerator (not shown) in the client SDP and routed to a matching accelerator in the server SDP. Once processed by the accelerator the packets are sent to G/W server 514 for address translation. This time the source address is changed to ‘E’, another address on G/W server 514 and the destination address is changed to ‘F’, the address of application server 531. The packets are then sent to the application provider and farther routed to the specific application server 531. Return traffic follows the reverse path and the reverse set of translations occur, until the traffic sent back to the client has the source address of ‘B’ and the destination address of ‘A’.

### Exemplary Acceleration Techniques

The accelerators used in the present invention can implement a variety of acceleration techniques. Typically, the choice of a particular acceleration technique is based on the application to be accelerated. Not all techniques can be used, or will be needed for all applications. Each acceleration technique may be embodied in a separate accelerator or multiple techniques may be combined in a single accelerator.

Since the accelerator modifies the data stream in some way, each accelerator accepts packets at a network interface and once the packets are processed sends the packets out a network interface. The same interface may be used for both sending and receiving. Once the packets are input, they are sent to the acceleration engine where one or more acceleration techniques are applied to the application data stream. Some of these acceleration techniques represent an end-to-end process and must communicate with another matching accelerator of the same type before being engaged and altering network traffic. In such instances, accelerators typically synchronize with each other to ensure this process occurs properly. Otherwise, the accelerator passes traffic ‘in the clear’ (i.e. unmodified) and the underlying network performance is seen at the application.

One acceleration technique that can be used with the present invention is TCP acceleration. TCP acceleration is a series of techniques designed to improve the throughput of TCP traffic under network conditions of high latency or high packet loss. TCP throughput has an inverse relationship with the round trip time or network latency. Additionally, various network stacks have a preconfigured maximum window size, which also limits the amount of data that can be in transit without an acknowledgement. When network latencies are larger, these two factors limit the throughput of a TCP session dramatically. The TCP acceleration technique rewrites various fields in the data stream to change the performance characteristics of the end-to-end TCP session. Since the original session is restored at the matching TCP accelerator, the effective throughput more closely matches the throughput of the non-accelerated components of the network path at either end of the SDPs. The effects are greatest when the network performance between the SDPs is at its worst. Other components of TCP acceleration such a pre-selective ACK and forward error correction are designed to reduce the effects of packet loss on the TCP session with some nominal overhead at the data stream.

Another acceleration technique is session splitting whereby large sessions are split into number smaller sessions and transmitted concurrently end to end. This permits the delay bandwidth product to be multiplied by the number of split sessions, increasing overall throughput. In addition, the throughput of each split session can be monitored, to effectively assess the performance qualities of the underlying network path. This is particularly useful when multiple distinct network paths are available. Split sessions can be divided and sent concurrently over the various network paths to be reassembled into a single session at the matching accelerator. In this example, high quality network paths may receive more of the sessions while low quality paths, receive fewer sessions or are avoided.

Another acceleration technique is application layer acceleration. Application layer acceleration represents techniques to overcome limitations of specific application implementations. An example is Common Internet File System (CIFS) acceleration where the application requires significant network communication between client and server for simple interactions. The techniques employed by CIFS acceleration terminate and proxy the connection at each accelerator and spoof the communication of the other endpoint. Thus if a client is communicating to a server through an accelerator, the accelerator associated with the client SDP takes on the role of the server and responds to certain requests per the protocol, while sending along the initial data and awaiting the required response from the application server. Likewise, the accelerator associated with the server SDP is also spoofing certain communication that would result from the client to ensure the communication is occurring per the protocol and as fast as possible. Thus, poorly written applications deployed over the wide area network are able to enjoy significant improvements in performance.

Compression/data referencing techniques are another acceleration technique that can be used with the present invention. Compression/data referencing techniques reduce the amount of data sent across the network and are mostly used for applications running over constrained connections. These techniques can also be used to reduce the effects of TCP acceleration that, by definition, increase the utilization of the network connections in the SDP. Compression finds patterns in the underlying data that can be represented with fewer bits. Another type of compression is data referencing that performs like tasks. Neither technique will work in the presence of encryption, since the encrypted data appears random and no patterns can be found. Data referencing can be used to dramatically improve the throughput of TCP if only the payloads of each packet are compressed. This allows each payload to carry more data and reduces the overall round trips that are required. This is the function of Virtual Window Expansion. Although again, encryption disrupts this process.

The only method to preserve compression/data referencing and Virtual Window Expansion in the presence of encryption is to decrypt the data, process the data per the accelerator and then re-encrypt the resulting data stream. This requires that the SDP and the ASNP be in the trust relationship of the customer, and to share the key material necessary to encrypt and decrypt the data. Although application providers may be unable or unwilling to share this information generally, it may be possible to share it for select applications and data sharing, which would enable these techniques in the presence of encryption. This has the effect of integrating the ASNP as part of a managed Virtual Private Network (VPN) service offering. Integrating security with the acceleration of the ASNP provides tremendous benefits and addresses the challenges of large diverse enterprise environments, such as those presented by remote workers and telecommuters.

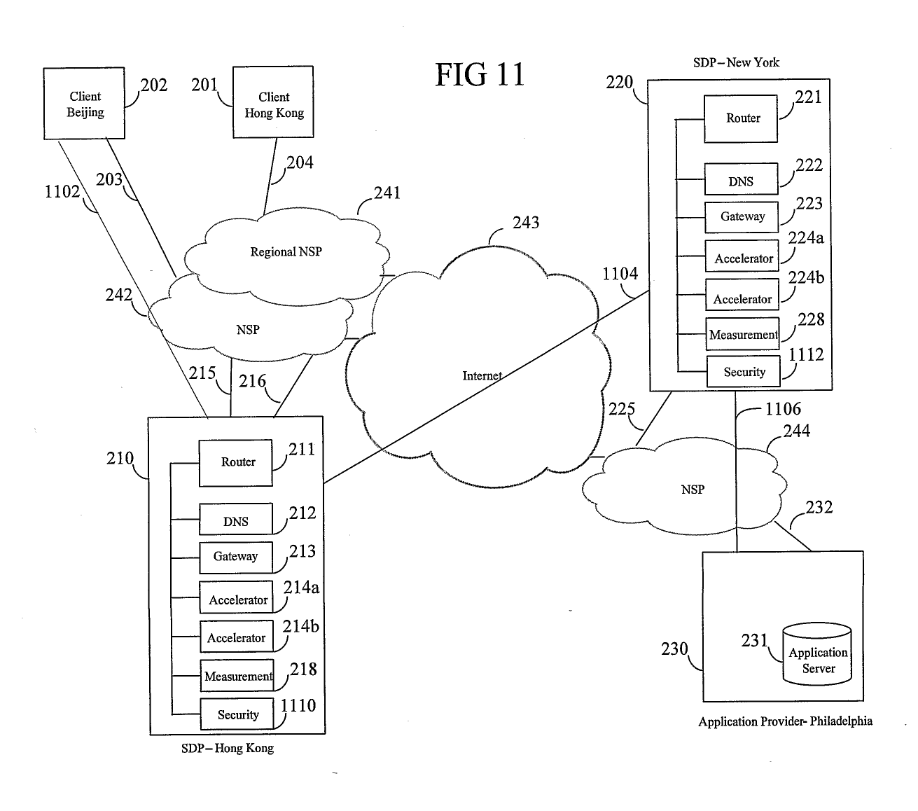

FIG. 11 illustrates the integration of security into the ASNP. Secure relationships are provided between the client and the client SDP 1102, the client SDP and the server SDP 1104, and the server SDP and the application provider 1106. A security box or VPN 1110, 1112 is provided at the client SPD and the server SDP. In some embodiments, such as SSL, the security is part of the application. In other embodiments, a security box (not shown) is added to the client and the application server. In the example illustrated by FIG. 11, encrypted data is sent from the client to the client SDP. The client SDP decrypts the data, accelerates the data, encrypts the data and then sends it to the server SDP. The server SDP decrypts the data, restores the data, encrypts the data and then sends it to the application server.

Data segment caching can also be used to accelerate application performance. Data segment caching is a form of caching where small elements of the data stream are stored on the disk or in the memory of each accelerator. This is not like full file caching where an entire copy of the file is stored, but instead only small, often repeated data segments are stored. An example might be the master slide pattern of a POWERPOINT file or data outside of the small changes made to an older version of the same file. When certain patterns are seen or requests for data are made by the application, the data can be taken from the disk instead of requested over the network, reducing the time to access the file and lowering the burden on the network.

The selection of an acceleration technique for a data stream can be automatic based on the type of application, which assumes that certain techniques work well with certain types of applications. Alternatively or in addition to a selection based on the type of application, the customer can select the technique(s) to be applied. The customer could make a selection through the management and administration portal. Each technique used could result in an additional cost for the service. The resulting system would be configured for all SDPs in all regions selected to only use the techniques selected.

The application accelerators may be deployed using commercially available systems for point-to-point acceleration, such as the hardware products currently available from Riverbed, Orbital Data, Peribit, Expand, Allot and other suppliers. Or they may be specific software implementing unique acceleration techniques deployed on servers in the SDPs.

As an alternative to using an accelerator associated with a server SDP, some web-based applications may operate with a single accelerator associated with the application server. Typical devices in this family of accelerators offload SSL, cache content files, manage connections, operate with certain browser-based features, such as compression, and apply certain application centric techniques, such as HTTP rewrite and pre-fetching of content. Some convert complicated enterprise applications (e.g. CIFS) into simple protocols, such as HTTP, accessible through a web browser. Many of these techniques are also applicable to a delivery network. In this embodiment, a matching accelerator is not required at a server SDP, although the various functions of the accelerators may be implemented across the client and server SDPs. For example, caching and compression may be implemented at the client SDP while session management and other application specific functions could reside at the server SDP or at (or near) the application server itself. Examples of accelerators suitable for this embodiment include accelerators offered by Redline, NetScaler, and FineGround.

### Exemplary Method Using Client SDP and Server SDP

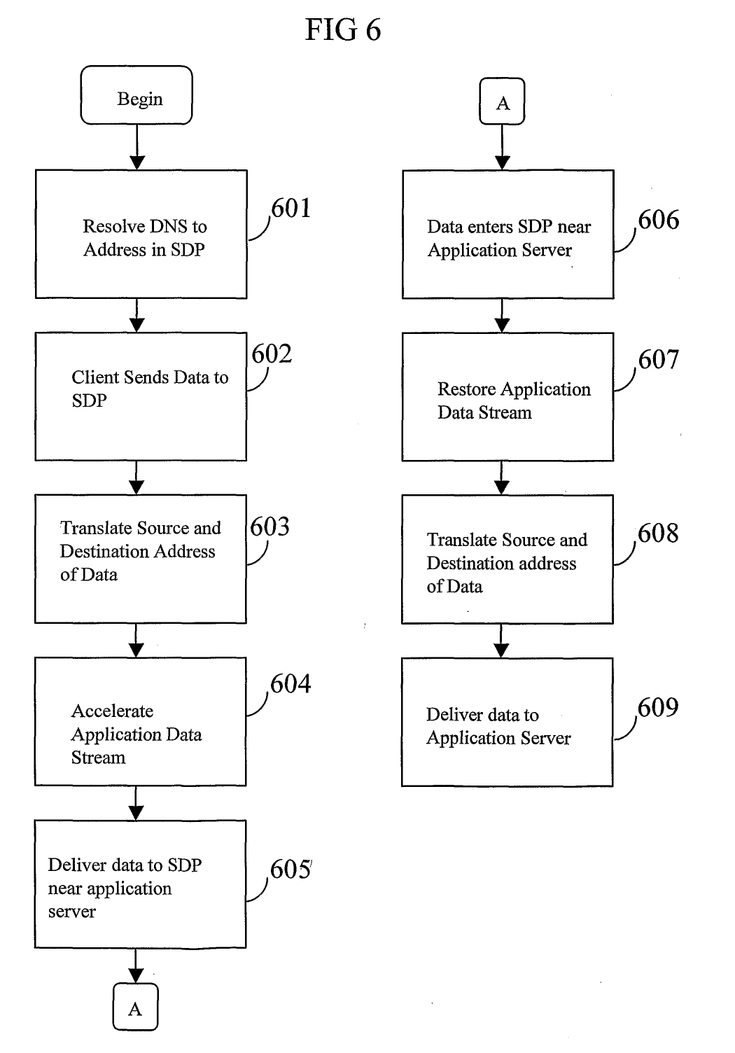

FIG. 6 illustrates the high level actions of one embodiment of the present invention that uses both a client SDP and a server SDP. The method is initiated when the client requests the address of the application server from its local DNS (LDNS) server. The DNS system resolves the request into an IP address associated with the client SDP in step 601. Additional details of the resolution of the address are provided in the section entitled “Exemplary Method Using DNS.” Once the IP address of the G/W server in the client SDP is known, the client initiates the application session by sending data to the IP address in step 602. The GIW server translates the address of the data in step 603 and passes the data to an application accelerator in the client SDP. The translated address identifies the server SDP as the destination address. If the accelerators in the SDP implement different acceleration techniques, then the selection of the accelerator is selected based on the type of application and/or the customer's specification. The application accelerator processes the data and enhances it in step 604.

Once the data is accelerated, the accelerated data is delivered to the server SDP using the destination address in step 605 and the accelerated data enters the server SDP in step 606. The accelerated data is sent to the matching accelerator in the server SDP where the same acceleration technique(s) are applied to the data in step 607 to restore the initial data stream. This is called restoration, meaning that the data stream is returned to its natural form. Specifically, the inverse technique(s) applied in the client SDP (acceleration, compression, etc.) are reversed and the original data stream emerges. The data is then forwarded to the GAW server in the server SDP and another address translation is performed in step 608 to identify the application server as the destination address. The data is the forwarded to the application server in step 609. Return data from the application server to the client follows a similar, but reversed method to that illustrated in FIG. 6.

### Selection of Server SDP

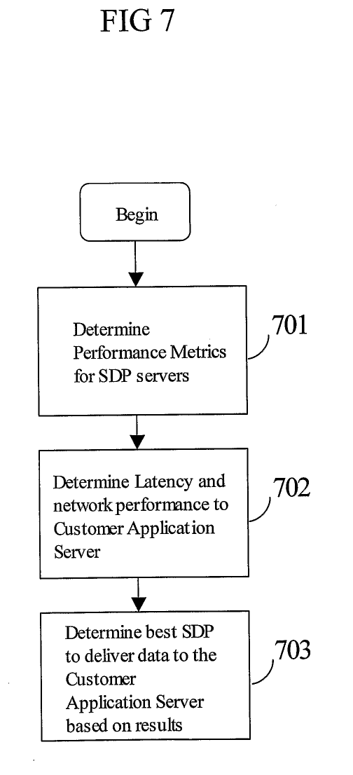

The ASNP typically provides a number of SDPs. FIG. 7 illustrates an exemplary method of selecting one of the SDPs as the server SDP. The candidate server SDPs are those SDPs that include an accelerator matched to the accelerator used in the client SDP. This method can be implemented in the measurement servers in the SDPs. Each candidate server SDP collects performance metrics to establish the load on the various servers of the SDP. If an SDP is low on available resources, then it will not be selected. These measurements occur constantly and are used to notify operators when a given system is down, or servers are running out of available resources such as network capacity, CPU, memory and the like. In step 701, the candidate server SDPs report their server performance metrics to the client SDP.

The measurement servers in each candidate server SDP also collect network measurements from the SDP towards the client SDP. Various network tests, such as ping, traceroute, UDP tests, TCP tests, download test, application specific tests and the like are employed by the measurement servers. In step 702, the candidate server SDPs report their network performance measurements to the client SDP.

In step 703, the best candidates server SDP in terms of network performance and available resources is selected as the server SDP. The metrics and measurements collected by the measurement servers in the candidate server SDPs and are used to select the candidate server SDP with the lowest network latency and best packet loss with sufficient available resources to handle the customer-configured traffic as the server SDP. The selection of a server SDP includes the identification of the specific addresses that are to be used by the G/W servers. The address translation rules are then configured on the G/W servers in the client SDP and the server SDP, a step not shown on this flowchart.

### Exemplary Method Using DNS

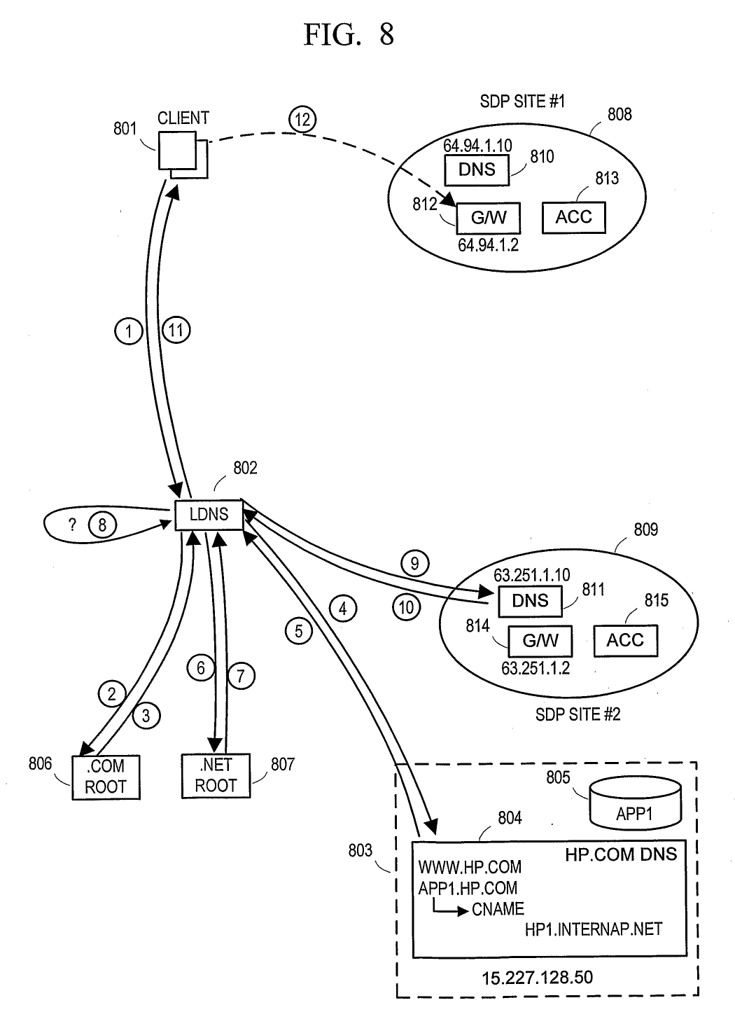

FIG. 8 illustrates an embodiment using DNS. DNS is one method for routing traffic into the client SDP. When the client 801 requests access to a given application on a large network such as the Internet, the Domain Name System is often used to translate human readable application names (e.g. appl.hp.com) into an IP address (e.g. 15.227.128.150). This translation or name resolution takes place at one of the globally distributed DNS servers. For example, when a client requests access to an application or enters an application domain name in a browser, the underlying software requires an IP address for the requested application domain name. The client will ask the preconfigured Local DNS (LDNS) server 802 to resolve the application name as shown in step 1. If the LDNS does not have an answer cached, it asks one of the root name servers for the top-level domain, in this case the .com root 806, for a server authoritative for the domain as shown in step 2. The root DNS will return the address of one or more servers authoritative for the domain in step 3.

Typically, the DNS server returned is under the direct control of the application provider 803. In this example, HP DNS server 804 is returned at the IP address 15.227.128.50. To enable the intelligent routing of data through the network, the application provider 803 makes the ASNP authoritative for the specific application domain name. This can be done at the root level for all of the application provider's domains, but is more commonly done at the application provider's DNS with a CNAME or other similar record as shown in 804. In the example illustrated by FIG. 8, the application provider is authoritative for *.hp.com, but “appl.hp.com” has a CNAME record to “hpl.internap.net”. The Client LDNS 802 queries the application provider DNS 804 for the domain name appl.hp.com in step 4 and the application provider DNS returns the CNAME “hpl.internap.net” in step 5.

The Client LDNS resolves the name (hpl .internap.net) in order to determine the proper DNS server to resolve the application name. If the name is not cached, then the Client LDNS 802 will query the net root nameserver 807 in step 6. The net root nameserver returns a list of configured DNS servers 810, 811 in a set of SDPs authorized to serve this application in step 7. Alternatively, the .net root nameserver returns a single IP address that is an anycast IP address for all DNS servers in all SDPs. For the anycast embodiment, the natural routing of the network would determine which SDP DNS server in which SDP would service the request.

In the embodiment illustrated by FIG. 8, the .net root nameserver returns two DNS servers, one 810 at the IP address 64.94.1.10 and another 811 at the IP address 65.251.1.10. If the root DNS responds with a list of addresses in step 7, then the client LDNS 802 selects one of the addresses using an internal methods specific to the locally running DNS process. Bind, a common DNS process selects the best performing DNS server on a more consistent basis, after trying all servers over a period of time. This process is beyond the control of the ASNP, but typically produces good results. The selection of a SDP DNS is shown in step 8 where SDP DNS 811 is selected. Another approach is to use one IP address for all SDP DNSs. When many servers share an IP address this is called IP anycast, which relies on the underlying routing of the network to select which DNS server gets the request. Again, since routing on other networks is beyond the control of the ASNP, this selection method is not easily controlled but should result in the selection of a SDP DNS that is reasonably close to the client LDNS 802.

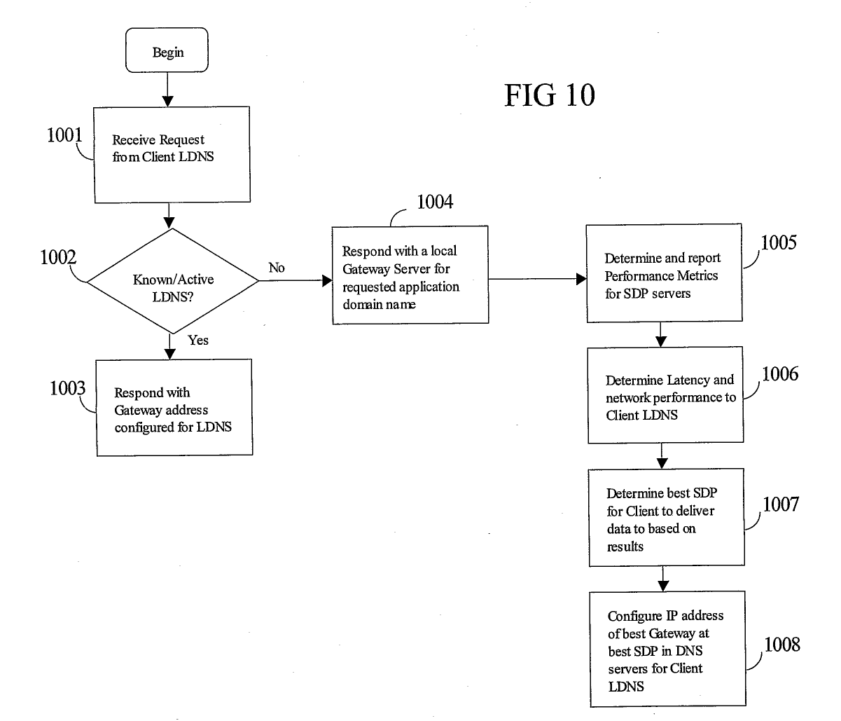

Once the SDP DNS has been selected, the client LDNS 802 requests the IP address from that server in step 9 and the SDP DNS provides the IP address in step 10. When the SDP DNS server receives a request from the client LDNS 802 it converts the application name into an IP address configured on a G/W server in one of the SDPs, preferably the SDP closest to the client 801 or with the best performing network path and available resources. This step is discussed in greater detail in connection with FIG. 10. In the example illustrated by FIG. 8, step 10 returns the IP address 64.94.1.2, configured on G/W server 812 in SDP 808. SDP 808 is a different SDP than the SDP that received the DNS request (SDP 809). The Time to Live (TTL) of the request is intentionally set low, even to zero, to ensure that the DNS system queries the network on nearly every request allowing additional performance information to be considered per query. In step 11, the client LDNS 802 responds with the IP address 64.94.1.2 and in step 12, the client 801 initiates the application connection to that address.

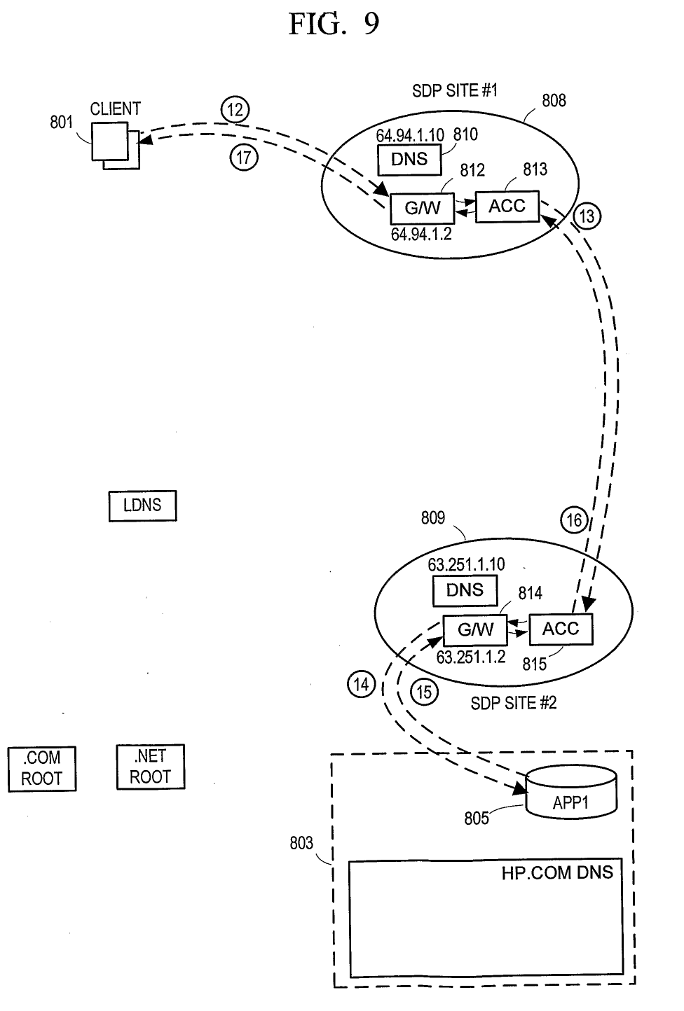

FIG. 9 continues the example of FIG. 8. Once G/W server 812 in client SDP 808 receives the data from the client 801, the G/W server translates the addressing and routes the data through accelerator 813. The accelerator 813 modifies the traffic according to the acceleration techniques implemented by the accelerator. In step 13, the traffic is routed to server SDP 809 according to the routing established for the new destination address, GAV server 814. Routing to G/W server 814 is through the matching accelerator 815, which restores the traffic. G/W server 814 translates the addressing and the data is routed to the application server 805 at the application provider 910 in step 14. The application server responds in step 15 by responding to the G/W server 814. GAW server 814 translates that addressing and routes the traffic through accelerator 815 and on to client SDP 808 in step 16. The accelerator 813 modifies the traffic and delivers the data stream to GIW server 812 where an address translation occurs, and the resulting data stream is routed on to the client in step 17.

### Selection of Client SDP

FIG. 10 illustrates an exemplary method of selecting one of the SDPs as the client SDP. The candidate client SDPs are those SDPs that include an accelerator suitable for the application requested by the client. A request from a client LDNS for an application domain name is received at an SDP DNS server in step 1001. A lookup is performed in the DNS process to determine if the client LDNS is a known LDNS that is associated with a valid record in step 1002. If the application network provider has performed measurements to a client LDNS and has determined the best SDP and GIW server to handle clients using that client LDNS, then the client LDNS is known. There is a record associated with a known client LDNS representing the performance information about the LDNS. The record includes a lifetime to ensure that the network is operating with fresh and valid data. If the LDNS is known and if the lifetime of the record associated with the LDNS indicates that the record is valid, then the DNS server responds with the G/W server IP address configured in the DNS in step 1003.

If the client LDNS is a new entry or the record contains old, possibly outdated information, then the network provider has not measured the performance to this LDNS for some time (if ever). If there are available resources in the local SDP of the DNS server, the DNS server responds to the request with the local GIW server configured for the application provider in step 1004. If local resources are not available, the DNS responds with the closest SDP to itself where resources are available. Once the request has been handled, the network begins measuring performance to the LDNS in the background to better service future requests. The first measurements, which occur constantly, are local performance metrics for all SDP servers as shown in step 1005. These measurements ensure the network is aware of available resources in every SDP. In addition to these measurements, the measurement servers initiate reverse DNS, and other network measurements back to the client LDNS from every configured SDP. These measurements assess the network quality between any given SDP and the Client LDNS as shown in step 1006. Once all of the measurements have been collected, the best SDP for the client LDNS is selected in step 1007 and the record for that client LDNS is configured in the SDP DNS servers associated with the client LDNS for future requests to use in step 1008.

Additional alternative embodiments will be apparent to those skilled in the art to which the present invention pertains without departing from its spirit and scope. Although FIGS. 8-10 illustrate DNS, the invention is not limited to DNS and other types of routing can be used. For example, routing to a predetermined location and subsequent routing to an SDP based on available resources and performance measurements is contemplated by the invention. The foregoing description uses the terms close, closest, nearby and other similar terms in connection with the selection of an SDP. The terms are not limited to physical proximity, but also describe the selection of the best SDP (or an acceptable SDP) based on network performance and SDP resources. Accordingly, the scope of the present invention is described by the appended claims and is supported by the foregoing description.

What is claimed is:

1. A method for routing data between a client that is requesting access to an application and an application server, comprising:
determining an acceleration technique based on the application;
identifying a client service delivery point (SDP) based on the acceleration technique, availability of SDP resources for a plurality of candidate client SDPs, and performance measurements between the client and the candidate client SDPs;
routing the data from the client to the client SDP;
applying the acceleration technique to the data;
identifying a server SDP based on the acceleration technique, availability of SDP resources for a plurality of candidate server SDPs, and performance measurements between the candidate server SDPs and the client SDP;
routing the accelerated data to the server SDP;
applying the acceleration technique to the accelerated data to restore the data; and
routing the data to the application server.

2. The method of claim 1, wherein the acceleration technique is selected from the group consisting of: TCP acceleration, application layer acceleration, compression/data referencing and data caching.

3. The method of claim 1, wherein routing the data from the client to the client SDP comprises using domain name system (DNS) to resolve network addressing.

4. The method of claim 1, wherein routing the data from the client to the client SDP comprises:
routing the data from the client to a predetermined address; and
routing the data from the predetermined address to the client SDP.

5. The method of claim 1, further comprising:
routing return data from the application server to the server SDP;
applying the acceleration technique to the return data;
routing the accelerated return data to the client SDP;
applying the acceleration technique to the accelerated return data to restore the return data; and
routing the return data to the client.

6. The method of claim 1, wherein identifying a client SDP comprises:
receiving an address resolution request for the client SDP at a candidate client SDP;
determining availability of resources at the candidate client SDP;
determining acceleration techniques available at the candidate client SDP;
determining performance measurements for traffic between the candidate client SDP and the client; and
based on the determinations, identifying the candidate client SDP as the client SDP.

7. The method of claim 1, wherein identifying a server SDP comprises:
receiving information at the client SDP regarding availability of resources at a candidate server SDP;
receiving information at the client SDP regarding performance measurements for traffic between the client SDP and the candidate server SDP; and
based on the determinations, identifying the candidate server SDP as the server SDP.

8. A method for routing data between a client that is requesting access to an application and an application server, comprising:
identifying a service delivery point (SDP) from a plurality of candidate SDPs based on availability of an acceleration technique suitable for the application at the candidate SDP, availability of SDP resources at the candidate SDPs, and performance measurements for the candidate SDPs;
routing the data from the client to the SDP;
applying the acceleration technique to the data; and
routing the data to the application server.

9. The method of claim 8, wherein the client is associated with an accelerator and wherein routing the data from the client to the SDP comprises routing the accelerated data to the SDP and applying the acceleration technique to the data comprises applying the acceleration technique to restore the data.

10. The method of claim 8, wherein the application server is associated with an accelerator and wherein routing the data to the application server comprises routing accelerated data to the application server.

11. The method of claim 8, wherein the application server is associated with an accelerator, further comprising:
routing accelerated return data from the application server to the SDP;
applying the acceleration technique to the accelerated return data to restore the return data; and
routing the return data to the client.

12. The method of claim 8, wherein identifying an SDP comprises:
receiving information regarding availability of resources at a first candidate SDP;
receiving information regarding performance measurements for traffic between the first candidate SDP and the client; and
based on the determinations, identifying the first candidate SDP as the SDP.

13. A system for routing data between a client that has requested access to an application and an application server, comprising:
a plurality of service delivery points (SDPs), wherein each service delivery point includes a gateway server that provides address translation, an accelerator that provides application acceleration, a measurement server that collects performance measurements, and an address resolution server,
wherein one of the SDPs is identified as a client SDP and another one of the SDPs is identified as a server SDP, the client SDP and the server SDP provide a selected acceleration technique, the data is routed from the client to the application server through the client SDP and the server SDP, and the data is accelerated at the client SDP and restored at the server SDP.

14. The system of claim 13, wherein the address resolution server is a domain name system (DNS) server.

15. The system of claim 13, wherein the gateway server at the client SDP performs an address translation to route the data from the client SDP to the server SDP.

16. The system of claim 13, wherein the gateway server at the server SDP performs an address translation to route the data from the server SDP to the application server.

17. The system of claim 13, wherein the acceleration technique is selected from the group consisting of: TCP acceleration, application layer acceleration, compression/data referencing and data caching.
